(19) United States
(12) Patent Application Publication
(10) Pub. No.: US 2024/0037458 A1
(43) Pub. Date: Feb. 1, 2024

(54) SYSTEMS AND METHODS FOR REDUCING NETWORK TRAFFIC ASSOCIATED WITH A SERVICE

(71) Applicant: Capital One Services, LLC, McLean, VA (US)

(72) Inventors: Mia RODRIGUEZ, Broomfield, CO (US); Michael Mossoba, Great Falls, VA (US); Vahid Khanagha, Rockville, MD (US); Joshua Edwards, Philadelphia, PA (US); Tyler Maiman, Melville, VA (US); Guadalupe Bonilla, Hyattsville, MD (US); Aysu Ezen Can, Cary, NC (US); Alexander Lin, Arlington, VA (US); Meredith L. Critzer, Midlothian, VA (US); Feng Qiu, Newark, DE (US)

(73) Assignee: Capital One Services, LLC, McLean, VA (US)

(21) Appl. No.: 17/877,390

(22) Filed: Jul. 29, 2022

(51) Int. Cl. G06N 20/20; G06K 9/62

(52) U.S. Cl. CPC G06N 20/20; G06K 9/6256; G06K 9/6262

(57) ABSTRACT

Systems and methods for reducing network traffic associated with a service. In some aspects, the systems and methods provide for using a first machine learning model to process a data stream for a communication with a user and generate a confidence score regarding whether to assign a communication suppression flag to the user account. Based on the confidence score not exceeding a first threshold, a communication suppression flag is not assigned to the user account. Based on the confidence score being between first and second thresholds, at least a portion of the data stream is extracted based on temporal proximity to a time stamp of an intent of the user to not receive further communications. Using a second machine learning model, the extracted portion of the data stream is processed to generate a prediction regarding whether to assign a communication suppression flag to the user account.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence often relies on large amounts of high-quality data. The process for obtaining this data and ensuring it is high-quality is often complex and time-consuming. Second, despite the mainstream popularity of artificial intelligence, practical implementations of artificial intelligence require specialized knowledge to design, program, and integrate artificial intelligence-based solutions, which limits the amount of people and resources available to create these practical implementations. Finally, results based on artificial intelligence are notoriously difficult to review as the process by which the results are made may be unknown or obscured. This obscurity creates hurdles for identifying errors in the results, as well as improving the models providing the results. These technical problems present an inherent problem with attempting to use an artificial intelligence-based solution for reducing network traffic associated with a service.

### SUMMARY

Systems and methods are described herein for novel uses and/or improvements to artificial intelligence applications for reducing network traffic associated with a service. As one example, systems and methods are described herein for reducing network traffic by using novel artificial intelligence applications to determine whether to suppress communications from a service to client devices associated with user accounts for the service. In particular, the described systems and methods use novel artificial intelligence applications to improve confidence scores for a machine learning model detecting from a data stream a user intent to not receive further communications from the service while still allowing the machine learning model to perform the detection in real time.

Conventional systems typically choose between models that can make fast predictions but lack accuracy or models that are more accurate but are slow to generate results. For example, conventional systems obtain real time predictions using models that lack accuracy in order to produce results within the required time constraints or network resource constraints. However, the difficulty in adapting artificial intelligence models to improve confidence scores for real time analysis of user intent while staying within the required constraints faces several technical challenges such as lack of training data and difficulty in determining rationale for when and how to retrain the models.

To overcome these technical deficiencies in adapting artificial intelligence models for this practical benefit, systems and methods disclosed herein include a two-level machine learning approach that, using a front-end machine learning model (e.g., to perform a preliminary analysis), detects in real time from a data stream a user intent to not receive further communications from the service, and based on an associated confidence score, extracts a portion from the data stream having temporal proximity to a time stamp of the user intent for processing using a back-end machine learning model (e.g., to perform an extensive analysis). For example, when processing a data stream using the front-end machine learning model to generate in real time a confidence score whether to assign to a user's account a communication suppression flag, if the confidence score falls between weak and strong confidence thresholds, only the portion of the data stream is processed using the back-end machine learning model and the front-end machine learning model is subsequently retrained based on a prediction from the hack-end machine learning model. Accordingly, the systems and methods described herein provide novel capabilities to improve confidence scores for real time analysis of user intent while staying within the required time constraints, further, the systems and methods described herein provide novel capabilities to reduce usage of network resources by using the front-end machine learning model to perform the preliminary analysis on the data stream and, if needed, transmitting only a portion of the data stream to the back-end machine learning model to perform the extensive analysis.

In some aspects, a system for reducing network traffic by suppressing communications from a service to client devices associated with user accounts with communication suppression flags includes one or more processors and a non-transitory, computer-readable medium comprising instructions that, when executed by the one or more processors, cause operations. The operations include obtaining, in real time, a data stream for a communication with a user associated with a user account of a service. The operations further include processing, using a front-end machine learning model, the data stream to generate a confidence score regarding whether to assign a communication suppression flag to the user account. The front-end machine learning model is trained to detect in real time from the data stream an intent of the user to not receive further communications from the service. The operations further include, in response to the confidence score being between a weak confidence threshold and a strong confidence threshold, extracting a portion of the data stream having temporal proximity to a time stamp of the intent of the user to not receive further communications from the service. The operations further include, in response to extracting the portion of the data stream, processing, using a back-end machine learning model, the portion of the data stream to generate a prediction regarding whether to assign a communication suppression flag to the user account. The back-end machine learning model is trained to detect from the portion of the data stream an intent of the user to not receive further communications from the service. The operations further include, in response to the prediction that a communication suppression flag be assigned to the user account, assigning a communication suppression flag to the user account to suppress further communications to the user from the service.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for network traffic associated with a service, in accordance with one or more embodiments.

FIG. 2 shows an illustrative diagram for reducing network traffic associated with a service, in accordance with one or more embodiments.

FIG. 3 shows illustrative components for a system used to reduce network traffic associated with a service, in accordance with one or more embodiments.

FIG. 4 shows a flowchart of the steps involved in reducing network traffic associated with a service, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

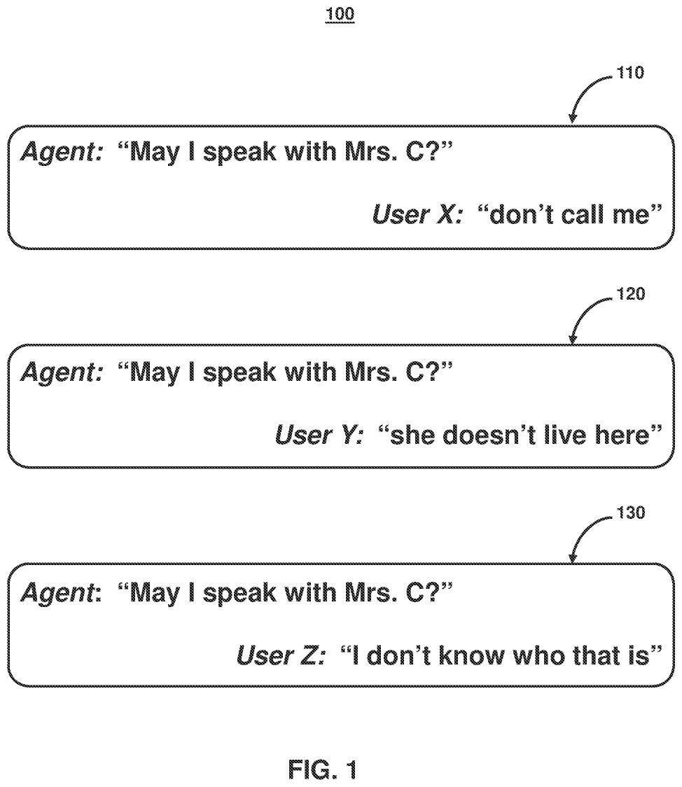

FIG. 1 shows an illustrative diagram 100 for network traffic associated with a service, in accordance with one or more embodiments. For example, FIG. 1 illustrates data streams with user intent to not receive further communications from the service. The system may reduce network traffic by suppressing communications from the service to client devices associated with user accounts where the user intent indicates that they do not wish to receive further communications from the service. For example, the system may detect this user intent and accordingly assign communication suppression flags to the corresponding user accounts.

In some embodiments, the user intent may be spoken ambiguously and may not always be interpreted by an agent of the service as a compliance risk (e.g., user intent to not receive further communications from the service). In such instances, compliance violations may occur if the agent does not take the proper steps to avoid the compliance risk. For example, the agent in data stream 110 may interpret user X's statement, “don't call me,” as user intent to not receive further communications form the service. However, the agent in data stream 120 and data stream 130 may not correctly interpret user intent to not receive further communications form the service based on user Y's statement, “she doesn't live here,” or user Z's statement, “I don't know who that is.” For example, this is because these statements are examples of phrases that have an implied request as compared to data stream 110 which has an explicit request for no further communications from the service.

In some embodiments, a data stream for a communication with a user associated with a user account of a service may be obtained in real time. Using a front-end machine learning model, the data stream may be processed to generate a confidence score regarding whether to assign a communication suppression flag to the user account. The front-end machine learning model may be trained to detect in real time from the data stream an intent of the user to not receive further communications from the service. Based on the confidence score being between a weak confidence threshold and a strong confidence threshold, a portion of the data stream having temporal proximity to a time stamp of the intent of the user to not receive further communications from the service may be extracted. Using a back-end machine learning model, the portion of the data stream may be processed to generate a prediction regarding whether to assign a communication suppression flag to the user account. The back-end machine learning model may be trained to detect from the portion of the data stream an intent of the user to not receive further communications from the service. Based on a prediction that a communication suppression flag be assigned to the user account, a communication suppression flag may be assigned to the user account to suppress further communications to the user from the service.

As referred to herein, a “data stream” may include information regarding a communication between a user and an agent of a service. The data stream may include data that is received from a data source that is indexed or archived by time. This may include streaming data (e.g., as found in streaming media files) or may refer to data that is received from one or more sources over time (e.g., either continuously or in a sporadic nature). A portion of a data stream may refer to a state or instance of the data stream. For example, a portion may refer to a current set of data corresponding to a given time increment or index value. In some embodiments, the data stream may comprise an audio signal, such as a telephone call or another suitable audio signal. In some embodiments, the data stream may comprise a video signal, such as a video call or another suitable video signal. In some embodiments, the data stream may comprise a textual signal, such as a text chat, a text message, or another suitable textual signal.

As referred to herein, a “communication” may include audio, video, or textual signals exchanged between an agent and a user of a service.

As referred to herein, “network traffic” may include communications exchanged between agents and users of the service at any given time, over the Internet, a mobile phone network, a mobile voice or data network (e.g., a 5G or LTE network), a cable network, a public switched telephone network, or other types of communications networks or combinations of communications networks.

As referred to herein, a “service” may include a call center office or service for receiving or transmitting a large volume of enquiries by telephone. In some embodiments, the service may include an inbound call center operated by a company to administer incoming product or service support or information enquiries from consumers. In some embodiments, the service may include an outbound call center operated for telemarketing, solicitation of charitable or political donations, debt collection, market research, emergency notifications, or urgent/critical needs blood banks. In some embodiments, the service may include a contact center operated for centralized handling of individual communications, including letters, faxes, live support software, social media, instant message, or email.

As referred to herein, a “client device” may include a device used by a user of the service. The client device may include any computing device, including, but not limited to, a laptop computer, a tablet computer, a hand-held computer, and other computer equipment (e.g., a server), including “smart,” wireless, wearable, and/or mobile devices.

As referred to herein, a “user account” may include information regarding a user receiving a communication from the service and stored in a database or another suitable data store. In some embodiments, the information regarding the user may include a name, a telephone number, a mailing address, an email address, a social media account, or other suitable information. In some embodiments, the information regarding the user may include a history of interactions between the user and the service, such as date or time for telephone calls or other suitable communications. In some embodiments, the information regarding the user may include preferences recorded from the user, such as preferred mode of communication and related contact information, preferred days or times to contact, or other suitable preference information.

As referred to herein, a “confidence score” may include a probability that a machine learning model is confident that a user has expressed an intent to not receive further communications from the service. For example, a confidence score of 0.33 may be a weak confidence threshold, while a confidence score of 0.67 may be a strong confidence threshold. The confidence score may be used to determine whether to rely on the front-end machine learning model or to query the back-end machine learning model.

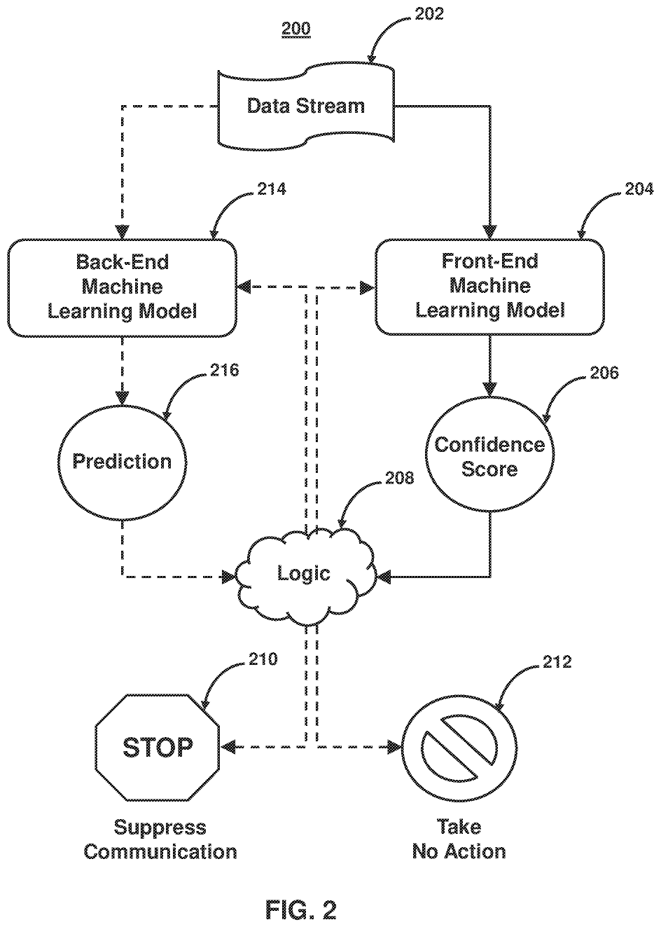

FIG. 2 shows an illustrative diagram 200 for reducing network traffic associated with a service, in accordance with one or more embodiments. For example, FIG. 2 illustrates a two-level machine learning approach that, using a front-end machine learning model 204 (e.g., to perform a preliminary analysis), detects in real time from a data stream 202 a user intent to not receive further communications from the service, and based on an associated confidence score 206, extracts a portion from the data stream having temporal proximity to a time stamp of the user intent for processing using a back-end machine learning model 214 (e.g., to perform an extensive analysis). For example, when processing a data stream using the front-end machine learning model 204 to generate in real time a confidence score 206 whether to assign to a user's account a communication suppression flag, if the confidence score falls between weak and strong confidence thresholds as determined by logic 208, the portion of the data stream 202 may be processed using the back-end machine learning model 214 and the front-end machine learning model 204 may be retrained based on prediction 216 from the back-end machine learning model 214. In some embodiments, the portion of the data stream 202 may be provided to another system for manual review. For example, during manual review, an agent, an expert, or another suitable entity may review the portion of the data stream 202 and provide their input regarding whether to assign to a user's account a communication suppression flag. The front-end machine learning model 204 may be retrained based on the input received from manual review of the portion of the data stream 202.

In some embodiments, the data stream 202 for a communication with a user associated with a user account of the service is obtained in real time. Using the front-end machine learning model 204, the data stream 202 is processed to generate the confidence score 206 regarding whether to assign a communication suppression flag to the user account. The front-end machine learning model 204 is trained to detect in real time from the data stream 202 an intent of the user to not receive further communications from the service. Based on the logic 208 determining that the confidence score 206 falls between a weak confidence threshold and a strong confidence threshold, a portion of the data stream 202 having temporal proximity to a time stamp of the intent of the user to not receive further communications from the service is extracted. Using the back-end machine learning model 214, the portion of the data stream 202 is processed to generate the prediction 216 regarding whether to assign a communication suppression flag to the user account. The back-end machine learning model 214 is trained to detect from the portion of the data stream 202 an intent of the user to not receive further communications from the service. Based on the logic 208 determining that the prediction 216 indicates that a communication suppression flag be assigned to the user account, a communication suppression flag is assigned to the user account to suppress further communications to the user from the service (suppress communication 210). Otherwise, the logic 208 determines that no action should be taken (take no action 212). The logic 208 may store information regarding the analysis as part of training data for the front-end machine learning model 204 or the back-end machine learning model 214.

In some embodiments, based on the logic 208 determining that the confidence score 206 falls between the weak confidence threshold and the strong confidence threshold, the logic 208 may retrain the front-end machine learning model 204 based on the prediction 216 from the back-end machine learning model 214.

In some embodiments, based on the logic 208 determining that the confidence score 206 does not exceed the weak confidence threshold, the logic 208 may determine that the user account not be assigned a communication suppression flag (take no action 212).

In some embodiments, based on the logic 208 determining that the confidence score 206 exceeds the strong confidence threshold, the logic 208 may determine that the user account be assigned a communication suppression flag (suppress communication 210) and may generate a notification to an agent of the service indicating that the user has expressed an intent to not receive further communications from the service.

In some embodiments, the logic 208 may obtain information regarding whether an agent of the service assigned a communication suppression flag to the user account, compare the information and the prediction 216 to determine whether they match, and based on the information not matching the prediction 216, the logic 208 may retrain the back-end machine learning model 214 based on the information.

In some embodiments, the front-end machine learning model may include an ensemble of models where each model is trained to predict a different intent of the user. The confidence score 206 regarding whether the user account be assigned a communication suppression flag may be generated by identifying a model in the ensemble configured to predict whether the user has expressed an intent to not receive further communications from the service and generating the confidence score 206 based on the model's prediction.

In some embodiments, the front-end machine learning model may include a neural network trained to predict an intent of the user from a plurality of intents. The confidence score 206 regarding whether the user account be assigned a communication suppression flag may be generated by identifying one or more nodes in a hidden layer of the neural network related to an intent to not receive further communications from the service and generating the confidence score 206 based on values associated with the one or more nodes.

As referred to herein, a “communication suppression flag” may be information included in a user account or another suitable data store to indicate whether the service may or may not communicate with the user. For example, for a call center service, the communication suppression flag may be stored as information in a do-not-call list which may include the user account or other suitable information to indicate that the user does not wish to receive further communications from the service.

In some embodiments, the system may determine whether to assign a communication suppression flag to a user account by using a front-end machine learning model, a back-end machine learning model, or a combination thereof. For example, by determining a confidence score using the front-machine learning model and determining that the confidence score exceeds a strong confidence threshold, the system may determine in real time or near real time that the user account be assigned a communication suppression flag. In another example, by determining a confidence score using the front-machine learning model and determining that the confidence score does not exceed a weak confidence threshold, the system may determine in real time or near real time that the user account not be assigned a communication suppression flag. In yet another example, by determining a confidence score using the front-machine learning model and determining that the confidence score falls between a weak confidence threshold and a strong confidence threshold, the system may query a back-end machine learning model and determine whether the user account be assigned a communication suppression flag based on a prediction from the back-end machine learning model. This prediction may be used to subsequently retrain the front-end machine learning model to improve confidence scores for future use.

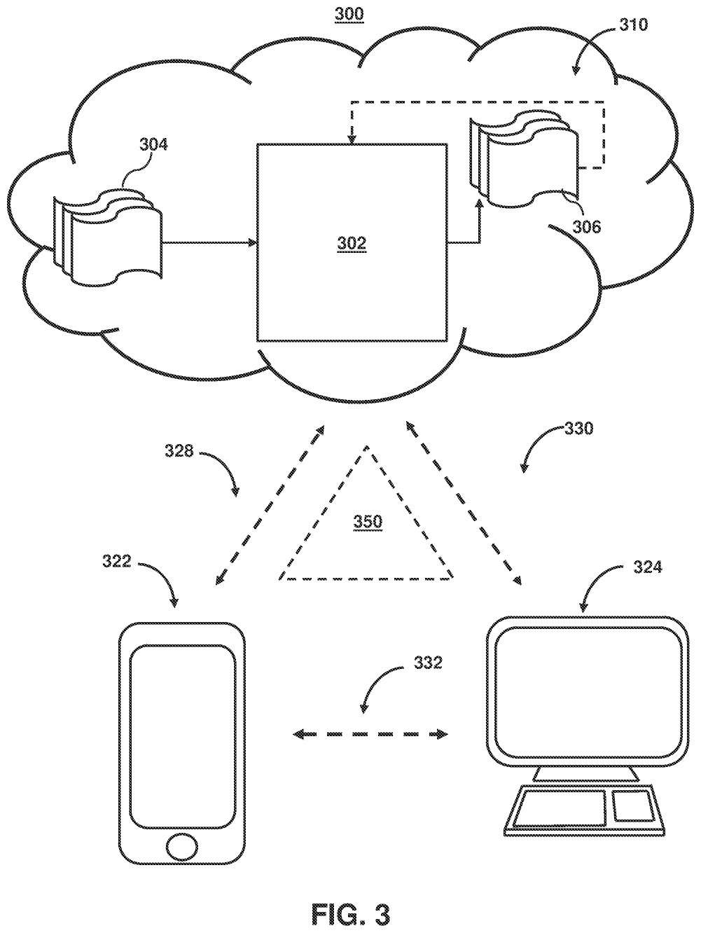

FIG. 3 shows illustrative components for a system used to reduce network traffic associated with a service, in accordance with one or more embodiments. As shown in FIG. 3, system 300 may include mobile device 322 and user terminal 324. While shown as a smartphone and a personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (“I/O”) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen devices, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein,

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include the front-end machine learning model 204, the logic 208, and the back-end machine learning model 214 described with respect to FIG. 2. Cloud components 310 may access the data stream 202 described with respect to FIG. 2. Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction. For example, the front-end machine learning model may be trained to detect in real time from the data stream an intent of the user to not receive further communications from the service. In another example, the back-end machine learning model may be trained to detect from the portion of the data stream an intent of the user to not receive further communications from the service.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., an intent of the user to not receive further communications from the service).

In some embodiments, the model (e.g., model 302) may automatically perform actions based on outputs 306. In some embodiments, the model (e.g., model 302) may not perform any actions. The output of the model (e.g., model 302) may be used to assign a communication suppression flag to a user account.

System 300 also includes API layer 350. API layer 350 may allow the system to generate summaries across different devices. In some embodiments, API layer 350 may be implemented on mobile device 322 or user terminal 324. Alternatively or additionally. API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

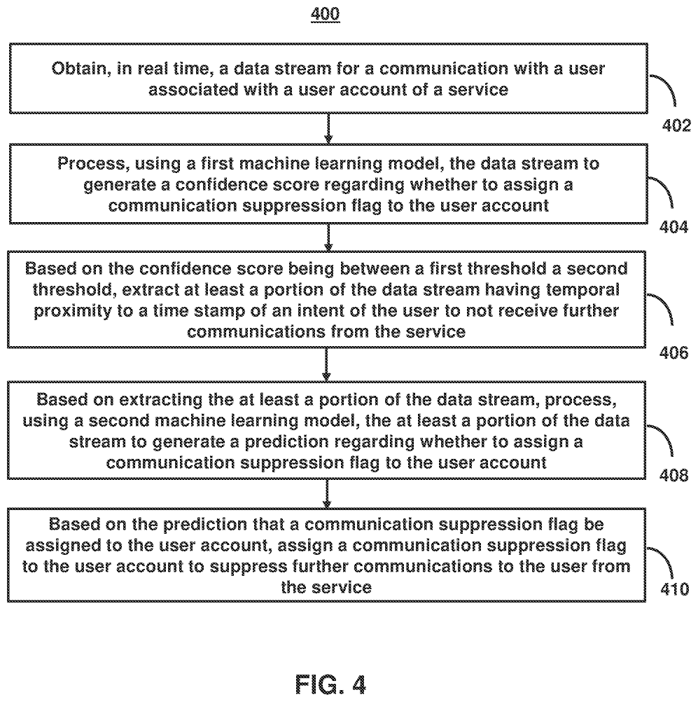

FIG. 4 shows a flowchart of the steps involved in reducing network traffic associated with a service, in accordance with one or more embodiments. For example, the system may use process 400 (e.g., as implemented on one or more system components described above) in order to reduce network traffic from the service.

At step 402, process 400 (e.g., using one or more components described above) obtains, in real time, a data stream for a communication with a user associated with a user account of a service. For example, process 400 may obtain in real time a data stream including information (e.g., an audio recording) regarding a communication (e.g., a telephone call) between an agent of the service (e.g., a call center service) and a user. By doing so, the system may analyze the data stream to determine whether there is an intent of the user to not receive further communications from the service.

At step 404, process 400 processes, using a first machine learning model a front-end machine learning model described above), the data stream to generate a confidence score regarding whether to assign a communication suppression flag to the user account. In some embodiments, the front-end machine learning model may be trained to detect in real time from the data stream an intent of the user to not receive further communications from the service. For example, process 400 may use the front-end machine learning model to generate a confidence score indicative of the user intent to not receive further communications from the service. The confidence score may be used to determine whether a communication suppression flag be assigned to the user account (e.g., by placing the user account or other suitable information on a do-not-call list for the call center service). By doing so, the system may determine whether network traffic may be reduced by suppressing further communications to the user from the service.

In some embodiments, the first machine learning model comprises an ensemble of models, each model is trained to predict a different intent of the user, and generating the confidence score regarding whether the user account be assigned a communication suppression flag includes identifying a model in the ensemble configured to predict whether the user has expressed an intent to not receive further communications from the service and generating the confidence score based on the model's prediction.

In some embodiments, the first machine learning model comprises a neural network, the neural network is trained to predict an intent of the user from a plurality of intents, and generating the confidence score regarding whether the user account be assigned a communication suppression flag includes identifying one or more nodes in a hidden layer of the neural network related to an intent to not receive further communications from the service and generating the confidence score based on values associated with the one or more nodes.

At step 406, based on the confidence score being between a first threshold (e.g., a weak confidence threshold) and a second threshold (e.g., a strong confidence threshold), process 400 extracts at least a portion of the data stream having temporal proximity to a time stamp of an intent of the user to not receive further communications from the service. For example, process 400 may extract a portion of the data stream including information (e.g., a portion of an audio recording) that indicates when the user expressed an intent to not receive further communications from the service. By doing so, the system may extract only the portion of the data stream that is relevant for determining the user intent and suitable for extensive analysis by the hack-end machine learning model (compared to preliminary analysis on the entire data stream by the front-end machine learning model).

At step 408, based on extracting the at least a portion of the data stream, process 400 processes, using a second machine learning model (e.g., a back-end machine learning model described above), the at least a portion of the data stream to generate a prediction regarding whether to assign a communication suppression flag to the user account. In some embodiments, the hack-end machine learning model may be trained to detect from the at least a portion of the data stream an intent of the user to not receive further communications from the service. For example, process 400 may use the back-end machine learning model to generate a prediction indicative of the user intent to not receive further communications from the service. The prediction may be used to determine whether a communication suppression flag be assigned to the user account (e.g., by placing the user account or other suitable information on a do-not-call list for the call center service). By doing so, the system may determine whether network traffic may be reduced by suppressing further communications to the user from the service.

At step 410, based on the prediction that a communication suppression flag be assigned to the user account, process 400 assigns a communication suppression flag to the user account to suppress further communications to the user from the service. For example, process 400 may assign a communication suppression flag to the user account by placing the user account or other suitable information on a do-not-call list for a call center service. By doing so, the system may reduce network traffic by suppressing further communications to the user from the service.

In some embodiments, based on the confidence score being between the first threshold (e.g., a weak confidence threshold) and the second threshold (e.g., a strong confidence threshold), process 400 retrains the first machine learning model (e.g., a front-end machine learning model) based on the prediction from the second machine learning model (e.g., a back-end machine learning model). For example, process 400 may improve confidence scores for the front-end machine learning model retraining the front-end machine learning model based on predictions from the back-end learning model in instances where the front-end machine learning model generated confidence scores between the weak and strong confidence thresholds. By doing so, the system may improve accuracy of the front-end machine learning model, thereby real time detection of user intent for future use.

In some embodiments, based on the confidence score not exceeding the first threshold (e.g., a weak confidence threshold), process 400 determines that the user account not be assigned a communication suppression flag. For example, process 400 may determine that the low confidence score is indicative of the user not expressing an intent to be placed on a do-not-call list for the call center service.

In some embodiments, based on the confidence score exceeding the second threshold (e.g., a strong confidence threshold), process 400 determines that the user account be assigned a communication suppression flag and generates a notification to an agent of the service indicating that the user has expressed an intent to not receive further communications from the service. For example, process 400 may determine that the high confidence score is indicative of the user expressing an intent to be placed on a do-not-call list for the call center service. By doing so, the system may reduce network traffic by suppressing further communications to the user from the service.

In some embodiments, process 400 obtains information regarding whether an agent of the service assigned a communication suppression flag to the user account, compares the information and the prediction to determine whether they match, and based on the information not matching the prediction, retrains the second machine learning model based on the information. For example, process 400 may determine that the agent placed a user on a do-not-call list for the call center service despite the back-end machine learning model predicting otherwise. Process 400 may use this training data to retrain the back-end machine learning model. By doing so, the system may retrain the back-end machine learning model and improve its accuracy for future use.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method, the method comprising: obtaining, in real time, a data stream for a communication with a user associated with a user account of a service; processing, using a front-end machine learning model, the data stream to generate a confidence score regarding whether to assign a communication suppression flag to the user account, the front-end machine learning model trained to detect in real time from the data stream an intent of the user to not receive further communications from the service; in response to the confidence score being between a weak confidence threshold and a strong confidence threshold, extracting a portion of the data stream having temporal proximity to a time stamp of the intent of the user to not receive further communications from the service; in response to extracting the portion of the data stream, processing, using a back-end machine learning model, the portion of the data stream to generate a prediction regarding whether to assign a communication suppression flag to the user account, the back-end machine learning model trained to detect from the portion of the data stream an intent of the user to not receive further communications from the service; and in response to the prediction that a communication suppression flag be assigned to the user account, assigning a communication suppression flag to the user account to suppress further communications to the user from the service.
2. A method, the method comprising: obtaining, in real time, a data stream for a communication with a user associated with a user account of a service; processing, using a first machine learning model, the data stream to generate a confidence score regarding whether to assign a communication suppression flag to the user account; based on the confidence score being between a first threshold a second threshold, extracting at least a portion of the data stream having temporal proximity to a time stamp of an intent of the user to not receive further communications from the service; based on extracting the at least a portion of the data stream, processing, using a second machine learning model, the at least a portion of the data stream to generate a prediction regarding whether to assign a communication suppression flag to the user account; and based on the prediction that a communication suppression flag be assigned to the user account, assigning a communication suppression flag to the user account to suppress further communications to the user from the service,
3. The method of any one of the preceding embodiments, further comprising: based on the confidence score being between the first threshold and the second threshold, retraining the first machine learning model based on the prediction from the second machine learning model.
4. The method of any one of the preceding embodiments, further comprising: based on the confidence score not exceeding the first threshold, determining that the user account not be assigned a communication suppression flag.
5. The method of any one of the preceding embodiments, further comprising: based on the confidence score exceeding the second threshold: determining that the user account be assigned a communication suppression flag; and generating a notification to an agent of the service indicating that the user has expressed an intent to not receive further communications from the service.
6. The method of any one of the preceding embodiments, further comprising: obtaining information regarding whether an agent of the service assigned a communication suppression flag to the user account; comparing the information and the prediction to determine whether they match; and based on the information not matching the prediction, retraining the second machine learning model based on the information.
7. The method of any one of the preceding embodiments, wherein the first machine learning model comprises an ensemble of models, each model trained to predict a different intent of the user, and wherein generating the confidence score regarding whether the user account be assigned a communication suppression flag comprises: identifying a model in the ensemble configured to predict whether the user has expressed an intent to not receive further communications from the service; and generating the confidence score based on the model's prediction.
8. The method of any one of the preceding embodiments, wherein the first machine learning model comprises a neural network, the neural network trained to predict an intent of the user from a plurality of intents, and wherein generating the confidence score regarding whether the user account be assigned a communication suppression flag comprises: identifying one or more nodes in a hidden layer of the neural network related to an intent to not receive further communications from the service; and generating the confidence score based on values associated with the one or more nodes.
9. A tangible, non-transitory, machine-readable medium storing instructions that, when executed by a data processing apparatus, cause the data processing apparatus to perform operations comprising those of any of embodiments 1-8.
10. A system comprising one or more processors; and memory storing instructions that, when executed by the processors, cause the processors to effectuate operations comprising those of any of embodiments 1-8.
11. A system comprising means for performing any of embodiments 1-8.

What is claimed is:

1. A system for reducing network traffic by suppressing communications from a service to client devices associated with user accounts with communication suppression flags, the system comprising:
one or more processors; and
a non-transitory, computer-readable medium comprising instructions that, when executed by the one or more processors, cause operations comprising:
obtaining, in real time, a data stream for a communication with a user associated with a user account of a service;
processing, using a front-end machine learning model, the data stream to generate a confidence score regarding whether to assign a communication suppression flag to the user account, the front-end machine learning model trained to detect in real time from the data stream an intent of the user to not receive further communications from the service;
in response to the confidence score being between a weak confidence threshold and a strong confidence threshold, extracting a portion of the data stream having temporal proximity to a time stamp of the intent of the user to not receive further communications from the service;
in response to extracting the portion of the data stream, processing, using a back-end machine learning model, the portion of the data stream to generate a prediction regarding whether to assign a communication suppression flag to the user account, the back-end machine learning model trained to detect from the portion of the data stream an intent of the user to not receive further communications from the service; and
in response to the prediction that a communication suppression flag be assigned to the user account, assigning a communication suppression flag to the user account to suppress further communications to the user from the service.

2. The system of claim 1, wherein the instructions cause further operations comprising:
in response to the confidence score being between the weak confidence threshold and the strong confidence threshold, retraining the front-end machine learning model based on the prediction from the back-end machine learning model.

3. The system of claim 1, wherein the instructions cause further operations comprising:
in response to the confidence score not exceeding the weak confidence threshold, determining that the user account not be assigned a communication suppression flag.

4. The system of claim 1, wherein the instructions cause further operations comprising:
in response to the confidence score exceeding the strong confidence threshold:
determining that the user account be assigned a communication suppression flag; and
generating a notification to an agent of the service indicating that the user has expressed an intent to not receive further communications from the service.

5. The system of claim 1, wherein the instructions cause further operations comprising:
obtaining information regarding whether an agent of the service assigned a communication suppression flag to the user account;
comparing the information and the prediction to determine whether they match; and
based on the information not matching the prediction, retraining the back-end machine learning model based on the information.

6. A method comprising:
obtaining, in real time, a data stream for a communication with a user associated with a user account of a service;
processing, using a first machine learning model, the data stream to generate a confidence score regarding whether to assign a communication suppression flag to the user account;
based on the confidence score being between a first threshold a second threshold, extracting at least a portion of the data stream having temporal proximity to a time stamp of an intent of the user to not receive further communications from the service;
based on extracting the at least a portion of the data stream, processing, using a second machine learning model, the at least a portion of the data stream to generate a prediction regarding whether to assign a communication suppression flag to the user account; and
based on the prediction that a communication suppression flag be assigned to the user account, assigning a communication suppression flag to the user account to suppress further communications to the user from the service.

7. The method of claim 6, further comprising:
based on the confidence score being between the first threshold and the second threshold, retraining the first machine learning model based on the prediction from the second machine learning model.

8. The method of claim 6, further comprising:
based on the confidence score not exceeding the first threshold, determining that the user account not be assigned a communication suppression flag.

9. The method of claim 6, further comprising:
based on the confidence score exceeding the second threshold:
determining that the user account be assigned a communication suppression flag; and
generating a notification to an agent of the service indicating that the user has expressed an intent to not receive further communications from the service.

10. The method of claim 6, further comprising:
obtaining information regarding whether an agent of the service assigned a communication suppression flag to the user account;
comparing the information and the prediction to determine whether they match; and
based on the information not matching the prediction, retraining the second machine learning model based on the information.

11. The method of claim 6, wherein the first machine learning model comprises an ensemble of models, each model trained to predict a different intent of the user, and wherein generating the confidence score regarding whether the user account be assigned a communication suppression flag comprises:
identifying a model in the ensemble configured to predict whether the user has expressed an intent to not receive further communications from the service; and
generating the confidence score based on the model's prediction.

12. The method of claim 6, wherein the first machine learning model comprises a neural network, the neural network trained to predict an intent of the user from a plurality of intents, and wherein generating the confidence score regarding whether the user account be assigned a communication suppression flag comprises:
identifying one or more nodes in a hidden layer of the neural network related to an intent to not receive further communications from the service; and
generating the confidence score based on values associated with the one or more nodes.

13. A non-transitory, computer-readable medium comprising instructions that, when executed by one or more processors, cause operations comprising:
obtaining, in real time, a data stream for a communication with a user associated with a user account of a service;
processing, using a first machine learning model, the data stream to generate a confidence score regarding whether to assign a communication suppression flag to the user account;
based on the confidence score being between a first threshold a second threshold, extracting at least a portion of the data stream having temporal proximity to a time stamp of an intent of the user to not receive further communications from the service;
based on extracting the at least a portion of the data stream, processing, using a second machine learning model, the at least a portion of the data stream to generate a prediction regarding whether to assign a communication suppression flag to the user account; and
based on the prediction that a communication suppression flag be assigned to the user account, assigning a communication suppression flag to the user account to suppress further communications to the user from the service.

14. The non-transitory, computer-readable medium of claim 13, wherein the instructions further cause operations comprising:
based on the confidence score being between the first threshold and the second threshold, retraining the first machine learning model based on the prediction from the second machine learning model.

15. The non-transitory, computer-readable medium of claim 13, wherein the instructions further cause operations comprising:
based on the confidence score not exceeding the first, threshold, determining that the user account not be assigned a communication suppression flag.

16. The non-transitory, computer-readable medium of claim 13, wherein the instructions further cause operations comprising:
based on the confidence score exceeding the second threshold:
determining that the user account be assigned a communication suppression flag; and
generating a notification to an agent of the service indicating that the user has expressed an intent to not receive further communications from the service.

17. The non-transitory, computer-readable medium of claim 13, wherein the instructions further cause operations comprising:
obtaining information regarding whether an agent of the service assigned a communication suppression flag to the user account;
comparing the information and the prediction to determine whether they match; and
based on the information not matching the prediction, retraining the second machine learning model based on the information.

18. The non-transitory, computer-readable medium of claim 13, wherein the first machine learning model comprises an ensemble of models, each model trained to predict a different intent of the user, and wherein generating the confidence score regarding whether the user account be assigned a communication suppression flag comprises:
identifying a model in the ensemble configured to predict whether the user has expressed an intent to not receive further communications from the service; and
generating the confidence score based on the model's prediction.

19. The non-transitory, computer-readable medium of claim 13, wherein the first machine learning model comprises a neural network, the neural network trained to predict an intent of the user from a plurality of intents, and wherein generating the confidence score regarding whether the user account be assigned a communication suppression flag comprises:
identifying one or more nodes in a hidden layer of the neural network related to an intent to not receive further communications from the service; and
generating the confidence score based on values associated with the one or more nodes.
